(19) United States
(12) Patent Application Publication
(10) Pub. No.: US 2010/0074993 A1
(43) Pub. Date: Mar. 25, 2010

(54) FOOD PRODUCTS COMPRISING PROBIOTIC MICROORGANISMS AND METHODS OF PREPARATION

(75) Inventors: Filip Cooreman, Sint-stevens-woluwe (BE); Rob Cogghe, Hamme (BE); Gerd Kennes, Scherpenheuvel (BE)

Correspondence Address: MICHAEL BEST & FRIEDRICH LLP, 100 E WISCONSIN AVENUE, Suite 3300, MILWAUKEE, WI, 53202, US

(73) Assignee: SENSIENT FLAVORS LLC, Indianapolis, IN (US)

(21) Appl. No.: 12/374,895

(22) PCT Filed: Jul. 26, 2006
(86) PCT No.: PCT/US06/29111

§ 371 Date: Nov. 20, 2009

(51) Int. Cl. A23D 9/007; A23P 1/08; A23L 1/10; A23L 1/164; A23L 1/30

(52) U.S. Cl. 426/61

(57) ABSTRACT

A modified food product comprising probiotic microorganisms and a process for making the modified food product. A food product is coated with layers of fat, or a fat containing composition and a probiotic microorganism. The layers may optionally include a salt or a whey or milk product. Examples of food products include, but are not limited to, cereal and cereal crisps.

### BACKGROUND OF THE INVENTION

Probiotic microorganisms include bacteria that can colonize the digestive system, and help maintain or restore the delicate balance of intestinal microflora. Ingestion of probiotic microorganisms may prevent or treat gastrointestinal problems such as diarrhea or abdominal pain, promote good digestion, boost immune function, and increase resistance to infection.

However, probiotic microorganisms may be destroyed by heat and other processing conditions. Consequently, foods containing probiotic bacteria commonly require refrigeration, and there are limitations on the types of food to which probiotic bacteria can be added.

The present invention provides a method for stably incorporating probiotic bacteria into food, and a food product containing probiotic bacteria which remain viable for extended periods of time.

### SUMMARY OF THE INVENTION

In one aspect, the invention provides a modified food product comprising a food product and a coating. The coating may comprise a fat or fat-containing composition, a probiotic microorganism and salt. In one embodiment, the coating may comprise a fat or fat-containing composition, a probiotic microorganism and at least one of a whey powder, a milk powder and a combination thereof.

In another aspect, the invention provides a method for producing a modified food product by adding a fat or fat-containing composition and a probiotic microorganism to a food product; and panning the food product with the fat or fat-containing composition and the probiotic microorganism to make a modified food product.

### BRIEF DESCRIPTION OF THE DRAWINGS

FIG. 1 shows the viability of probiotic bacteria in two embodiments of the modified food product of the invention over time.

FIG. 2 shows the shows the viability of probiotic bacteria in three embodiments of the modified food product of the invention over time.

FIG. 3 shows the viability of probiotic bacteria in cereal bars and muesli comprising a modified food product of the invention over time.

### DETAILED DESCRIPTION OF THE INVENTION

Before any embodiments of the invention are explained in detail, it is to be understood that the invention is not limited in its application to the details of construction and the arrangement of components set forth in the following description. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The present invention is generally directed to a food product comprising probiotic microorganisms, and methods of making products comprising probiotic microorganisms. The food products of the instant invention are palatable to the consumer, and the probiotic microorganisms remain viable during storage of the food product.

As used herein, the term “probiotic microorganism” means a microorganism which confers a benefit when grown in a particular microenvironment by, e.g., directly inhibiting or preventing the growth of other biological organisms within the same microenvironment. Probiotic microorganisms include, but are not limited to, bacteria which possess the ability to grow within the gastrointestinal tract and provide a benefit to the host.

Benefits to the host may include, but are not limited to, displacement, inhibition or destruction of pathogenic organisms. Probiotic microorganisms may compete with pathogenic microorganism for nutrients and space in the gastrointestinal tract and/or creating a low-pH environment for pathogenic microorganisms by producing organic acids, such as lactic acid, acetic acid, and propionic acid. Probiotic microorganisms also produce natural antibiotics, such as acidolin, acidophilin, bulgaricin, and plantaricin or bacteriocines, and other substances that inhibit the growth of pathogens.

Other benefits to the host include, but are not limited to, the preservation of the natural microflora in the intestine, the prevention or treatment of gastrointestinal problems such as diarrhea or abdominal pain, the suppression of an inflammatory response and control of intestinal inflammatory diseases, the promotion of good digestion, the boosting of immune function, and increasing resistance of the host to infection.

Examples of suitable probiotic microorganisms include, but are not limited to, yeasts and molds such as Saccharomyces, Debaromyces, Candida, Pichia, Torulopsis, Aspergillus, Rhizopus, Mucor and Penicillium. Probiotic bacteria suitable for use in the present invention include, but are not limited to, strains of Lactobacillus, Bifidobacterium, Bacteroides, Clostridium, Fusobacterium, Melissococcus, Propionibacterium, Enterococcus, Lactococcus, Staphylococcus, Peptostrepococcus, Bacillus, Pediococcus, Micrococcus, Leuconostoc, Weissella, Aerococcus, Oenococcus and Streptococcus.

Specific examples of suitable probiotic microorganisms include, but are not limited to, Saccharomyces cereviseae, Bacillus coagulans, Bacillus licheniformis, Bacillus subtilis, Bifidobacterium animalis, Bifidobacterium bifidum, Bifidobacterium breve, Bifidobacterium infantis, Bifidobacterium lactis, Bifidobacterium longum, Enterococcus faecium, Enterococcus faecalis, Lactobacillus acidophilus, Lactobacillus alimentarius, Lactobacillus bulgaricus, Lactobacillus casei (e.g. Shirota or subsp. casei), Lactobacillus paracasei (e.g. F19, subsp. paracasei), Lactobacillus curvatus, Lactobacillus delbruckii subsp. lactis, Lactobacillus farciminus, Lactobacillus gasseri, Lactobacillus helveticus, Lactobacillus johnsonii, Lactobacillus reuteri, Lactobacillus rhamnosus (Lactobacillus GG), Lactobacillus sake, Lactococcus lactis, Micrococcus varians, Pediococcus acidilactici, Pediococcus pentosaceus, Pediococcus acidilactici, Pediococcus halophilus, Streptococcus faecalis, Streptococcus thermophilus, Staphylococcus carnosus, and Staphylococcus xylosus.

As used herein, a “food product” is a composition that is consumed and which primarily provides energy or nutrition to a consumer. Suitable food products include, but are not limited to, cereals, breakfast cereals, cereal bars, cereal crisps, crisps, crackers, chips, snack chips (e.g., sliced potato chips), cookies, cakes, pretzels, fabricated snacks (e.g., fabricated chips such as tortilla chips, potato chips, potato crisps), extruded snacks, chewing gum, candy, various bread products (e.g., biscuits, toast, buns, bagels, and tortillas), fruit, dried fruit, beef jerky, pasta, hot dogs, sliced meats, cheese, pancakes, waffles, dried fruit film, toaster pastries, ice cream cones. Suitable food products may include those which have a water activity of at least about 0.03, particularly at least about 0.05, and more particularly at least about 0.1. Suitable food products may include those which have a water activity of less than about 0.85, particularly less than about 0.6, more particularly less than about 0.3, and even more particularly less than about 0.25.

Modified food products of the invention can be incorporated into a number of foods, including but not limited to, muesli, breakfast cereals, ice cream, gelatin, ice cream sandwiches, ice pops, yoghurt, desserts, cheese cake, pies, cup cakes, English muffins, pizza, pies, meat patties, and fish sticks. Suitable foods also may include water activity protected foods or food products that are preserved in a frozen state including, but not limited to, desserts, custards, bavarois, mousses, and fish sticks.

Suitably, the food product, such as a cereal or cereal crisp, may comprise at least about 1%, at least about 5%, at least about 10%, at least about 20%, at least about 25%, or at least about 30% of the total weight of the modified food product of the invention. Suitably, the food product may comprise less than about 80%, less than about 70%, less than about 60%, less than about 50%, or less than about 40% of the total weight of the modified food product of the invention.

As used herein, a “cereal” is a food product having as its primary ingredient, or one of its primary ingredients, ground, crushed or processed cereal grains, or parts thereof, or processed plant starch or flour. Cereal grains include, but are not limited to, grains from wheat, barley, oats, maize, rye, spelt, and rice. Plant starch or flour may be suitably obtained from starch storing plant parts, such as beans (including soy beans), potatoes, beets or cereal grains. Cereals suitable for use in the invention may comprise individual pieces of any shape, irregular or regular, the pieces having an average diameter of less than about 4 cm, less than about 3 cm, less than about 2 cm, less than about 1 cm, less than about 0.5 cm or less than about 0.25 cm. Suitable cereals may comprise pieces having an average diameter of at least about 0.03 cm, at least about 0.05 cm, at least about 0.07 cm, at least about 0.1 cm or at least about 0.2 cm. Suitable cereals may optionally contain additional fat, sugar and protein. Suitable cereals include muesli and breakfast cereal mixes.

In one aspect of the invention, the modified food product of the invention comprises a center of a suitable food product, upon which one or more layers of fat, or fat-containing compositions, are deposited. Suitably, at least about 50, at least 70, at least about 80, at least about 90, at least about 100 or at least about 105 layers are deposited. Suitably less than about 500, less than about 250, less than about 200, less than about 175, less than about 150, less than about 125, less than about 120 layers are deposited.

Fats suitable for use in the present invention include conventional fats and oils used in food products. Both conventional fatty triglyceridic materials such as oils and solid fats are suitable for use herein, as well as blends of oils and fats. Also useful herein are hydrogenated or partially hydrogenated oils such as vegetable oils, including, but not limited to, canola, corn, safflower, soybean, coconut, palm kernel, cottonseed or fractionated oils and animal derived fats. Suitable fat containing compositions include, but are not limited to, those containing fats and polyols, fats and sugars or fats and artificial sweeteners, and include, but are not limited to, chocolate (including white, dark and milk chocolate) and chocolate substitutes. Suitably the fat or fat-containing composition may comprise at least about 20%, at least about 30%, at least about 40%, at least about 45%, or at least about 50% of the total weight of the modified food product of the invention. Suitably the fat or fat-containing composition may comprise less than about 85%, less than about 75%, less than about 65%, less than about 60% or less than about 55% of the total weight of the modified food product of the invention.

Other components, such as beta carotene may be optionally included with the fat, or fat containing composition. Suitably, beta-carotene may be used at least 0.005%, at least 0.008%, or at least 0.01% of the total weight of the modified food product of the invention. Suitably, beta-carotene may be used at less than 0.5%, less than 0.4%, less than 0.3%, less than 0.2% or of the modified food product of the invention.

Probiotic microorganisms may suitably be suspended in a premix powder prior to their application to the food product. In one embodiment, the premix powder may comprise salt and milk powder or whey powder. Suitable salts include, but are not limited to, sodium chloride and potassium chloride. Suitable milk or whey powders include, but are not limited to, milk powder, whey powder, skimmed whey powder, skimmed milk powder, lactose, whey protein concentrate, demineralized whey powder and casein. Suitably, the salt may be present in the premix powder to provide a concentration of the total weight of the modified food product of the invention of at least about 0.1%, at least about 0.5%, at least about 0.75%, at least about 1%, or at least about 1.5%. Suitably, the salt may be present in the premix powder to provide a concentration of the total weight of the modified food product of the invention of less than about 20%, less than about 15%, less than about 10%, less than about 5% or less than about 2.5%. Suitably, the whey powder may be present in the premix powder to provide a concentration of the total weight of the modified food product of the invention of at least about 0.1%, at least about 0.5%, at least about 0.75%, or at least about 1%. Suitably, the whey powder may be present in the premix powder to provide a concentration of the total weight of the modified food product of the invention of less than about 20%, less than about 15%, less than about 10%, less than about 5% or less than about 3%. The addition of salt, milk powder or whey powder to the premix powder may enhance the viability of the microorganisms in the modified food product over extended periods.

Suitably, the probiotic microorganism may be present in the premix powder to provide a concentration of the total weight of the modified food product of the invention of at least about 0.1%, at least about 0.5%, at least about 0.75%, at least about 1% or at least about 1.5%. Suitably, the whey powder may be present in the premix powder to provide a concentration of the total weight of the modified food product of the invention of less than about 10%, less than about 8%, less than about 6%, less than about 4% or less than about 3%.

Other components may also be suitably included in the premix powder, including, but not limited to, sugars (e.g., glucose, sucrose, fructose, mannose, dextrose, maltose, powdered sugar) vanilla (e.g., natural or artificial vanillin), polyols (e.g., polyglycols and polyglycerols), flavors (e.g., natural or artificial), colors (e.g., natural or artificial), natural extracts, vitamins, minerals, fibers, prebiotics, or Ω3-fatty acids. Suitably, sugar may be present in the premix powder to provide a concentration of the total weight of the modified food product of the invention of at least about 0.1%, at least about 1%, at least about 2.5%, at least about 5% or at least about 7.5%. Suitably, sugar may be present in the premix powder to provide a concentration of the total weight of the modified food product of the invention of less than about 30%, less than about 25%, less than about 20%, less than about 15% or less than about 12%. Suitably, vanilla or vanillin may be present in the premix powder to provide a concentration of the total weight of the modified food product of the invention of at least about 0.01%, at least about 0.012%, at least about 0.015%, or at least about 0.017%. Suitably, vanilla or vanillin may be present in the premix powder to provide a concentration of the total weight of the modified food product of the invention of less than about 0.5%, less than about 0.25%, less than about 0.1%, or less than about 0.75%.

The modified food product of the invention may be suitably made using panning technology, or using a belt coater or turbine coater to deposit the layers of fat, or fat-containing compositions, and probiotic microorganisms onto the food product. The probiotic microorganisms are suitably incorporated into the one or more fat, or fat-containing composition, layers. Suitably the fat, or fat-containing compositions are added to the food product in a liquid form. After a layer of fat, or fat-containing composition is deposited, the food product may be suitably cooled so that the layer sets or hardens. Cooling may suitably be achieved, for example, by blowing or forcing cold air, N₂, CO₂ or other cooling media over the food product. The layering process may be suitably repeated until a desired size of modified food product is attained. Suitably, the probiotic culture is placed near the food product center. While not wishing to be bound by any particular theory, it is presumed that the fat provides a barrier and protects the probiotic culture. Suitably the number of layers of fat or fat-containing compositions deposited onto the food product is at least about 15, at least about 25, at least about 40, at least about 50, at least about 60, at least about 70, at least about 80, at least about 90 or at least about 100. Suitably the number of layers of fat or fat-containing compositions deposited onto the food product is less than about 150, less than about 125, less than about 120, or less than about 115. Suitably, the thickness of the layers may be at least about 0.05 mm, at least about 0.1 mm, at least about 0.25 mm, at least about 0.5 mm, at least about 0.7 mm or at least about 0.8 mm. Suitably, the thickness of the layers may be less than about 5 mm, less than about 4 mm, less than about 3 mm, less than about 2 mm, less than about 1.5 mm, less than about 1.25 mm or less than about 1.0 mm.

The fat or fat-containing composition used to coat the food product is suitably melted to facilitate its distribution over the surface. Suitably, the fat is completely, or almost completely, melted. Complete, or almost complete, melting of the fat or fat containing composition may facilitate at least one of an even distribution of the probiotic culture over the centers, the creation of a smooth surface which protects the probiotic culture from its environment, and the creation of a layering effect sufficient to protect the probiotic culture from its environment.

Other additional components may be added to the modified food product, including, but not limited to sugars, polyols, flavors, colors, natural extracts, malt extracts, vitamins, minerals, fibers, prebiotics, and Ω3-fatty acids.

The viability of the probiotic microorganisms in the modified food product of the invention can be tested using any technique known in the art. For example, the number of colony forming units or growth of the microorganism in culture, extracted from the modified food product, can be assessed after storage of the modified food product under a variety of environmental conditions for extended periods of time.

Probiotic microorganisms incorporated into food products of the invention may remain viable over extended periods of time. Viability of the microorganisms may be measured by any technique known in the art, including, but not limited to, counting colony forming units (CFUs) in a sample from which the microorganisms have been extracted, or by monitoring the growth rates of microorganisms extracted from the food product. Viability of the probiotic microorganisms measured after a period of time may be expressed as a percentage of the initial viability of the microorganisms in the sample. For example, at least about 0.1%, at least about 0.5%, at least about 0.75%, at least about 1%, at least about 2.5%, at least about 5%, at least about 7.5%, at least about 10%, at least about 25%, or at least about 50% of the probiotic microorganisms may remain viable during storage of the food product over time. Viability of the probiotic microorganisms may remain after storage of the food product for a period of time of at least about, or about, −30° C., at least about, or about, −20° C., at least about, or about, 0° C., at least about, or about, 4° C., at least about, or about, 10° C., at least about, or about, 15° C., at least about, or about, 20° C., at least about, or about, 25° C., at least about, or about, 30° C., and at least about, or about, 35° C. Viability of the probiotic microorganisms may remain after storage of the food product for at least about 1 week, at least about 2 weeks, at least about 3 weeks, at least about 4 weeks, at least about 2 months, at least about 3 months, at least about 4 months, at least about 6 months, at least about 9 months, at least about 12 months, at least about 18 months and at least about 2 years.

### EXAMPLES

### Example 1

### Production of Probiotic Coated Cereal Using a Panning Process

800 g of a probiotic culture of Lactobacillus casei was mixed with 645 g NaCl and 385 g whey powder in a powder blender to form a premix powder.

12 kg of cereal crisp (obtained from Titusfield, Peterborough, UK) was added to a traditional panning apparatus and the panning process was started. A first shot of 170 g hydrogenated vegetable fat, which was enriched with beta carotene, was poured evenly over the cereal with a ladle to form a uniform layer. Twelve more layers of fat (170 g each) were then created over the cereal crisp by pouring the fat and allowing it to cool. A fourteenth shot of 170 g fat was then added to the cereal crisp. The probiotic premix powder was then added manually to the panning mix while the fat was still a liquid on the centers, and before the centers began to stick together, and distributed over the centers by the panning process to form a uniform layer on the fat. The fat picked up and encapsulated the probiotic bacteria during the panning process. Cold nitrogen gas was then sprayed over the panned coated cereal crisp until the coating set over the cereal crisp.

Ninety-seven more cycles of applying 170 g fat to the coated cereals were made according to the above description. Cooling with nitrogen gas was carried out periodically after the addition of the fat, if the cereal crisps appeared to stick together. At approximately 12 cycle intervals, 430 g of sugar and 1.25 g powdered vanillin were added to the panned cereal crisp with the fat. The sugar assisted in preventing the cereal crisps from sticking together. The total amount of sugar added was 3.45 kg and the total amount of vanillin added was 9 g. The total thickness of the coating layers over the cereal crisp was approximately 0.9 mm.

### Example 2

### Viability of the Probiotic Bacteria in the Coated Cereals with Added Salt and Whey Powder

The viability of the probiotic bacteria within two coated cereals of the invention, was tested over an extended period of time. Sample 1 contained no added salt or whey powder, whereas sample 2 contained 4.3% whey powder and 1.5% salt (sodium chloride). The coated cereals had the following compositions shown in Table 1:

TABLE 1

| | Sample 1 | Sample 2 |
|---|---|---|
| Component | (wt. %) | (wt. %) |
| Cereal | 30% | 30% |
| Fat | 50% | 30% |
| Whey powder | 0% | 4.3% |
| Salt | 0% | 1.5% |
| Other components | 20% | 34.2% |

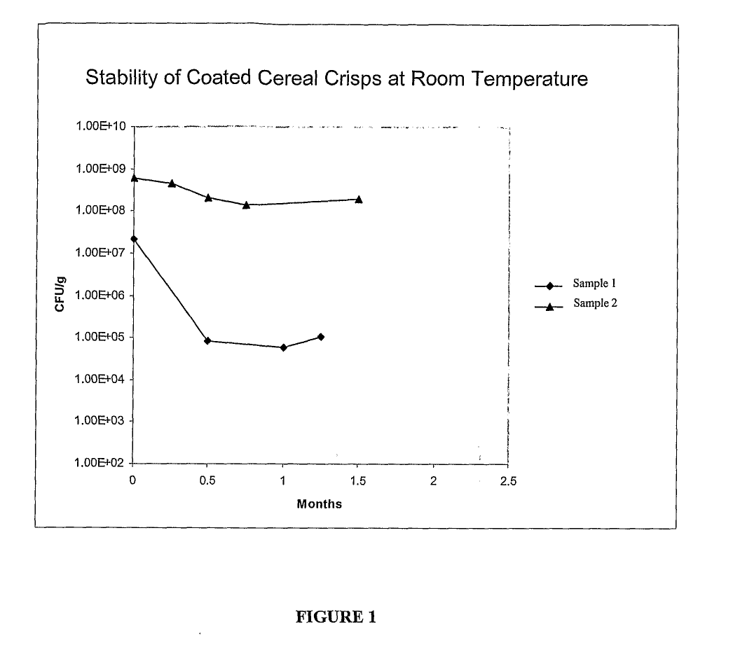

Each sample was evaluated for several weeks at room temperature, i.e. about 20° C. Bacteria were extracted from the muesli and the viability of the probiotic bacteria was assessed by culturing and counting colony forming units. The results, shown in FIG. 1, show the viability of the bacteria over time is increased by the inclusion of salt and whey powder in the composition.

### Example 3

### Viability of the Probiotic Bacteria in Coated Cereals of the Invention

The viability of the probiotic bacteria within coated cereals was tested over an extended period of time. The coated cereals had the following compositions shown in Table 2:

TABLE 2

| | Sample 3 | Sample 4 | Sample 5 |
|---|---|---|---|
| Component | (wt. %) | (wt. %) | (wt. %) |
| Cereals | 50 | 40 | 24 |
| Sugar | 13 | 18 | 44.385 |
| Probiotic culture | 2 | 2 | 1.6 |
| Fat | 35 | 40 | 22 |
| Beta caroteen | 0 | 0 | 0.015 |
| glycerine | 0 | 0 | 8 |

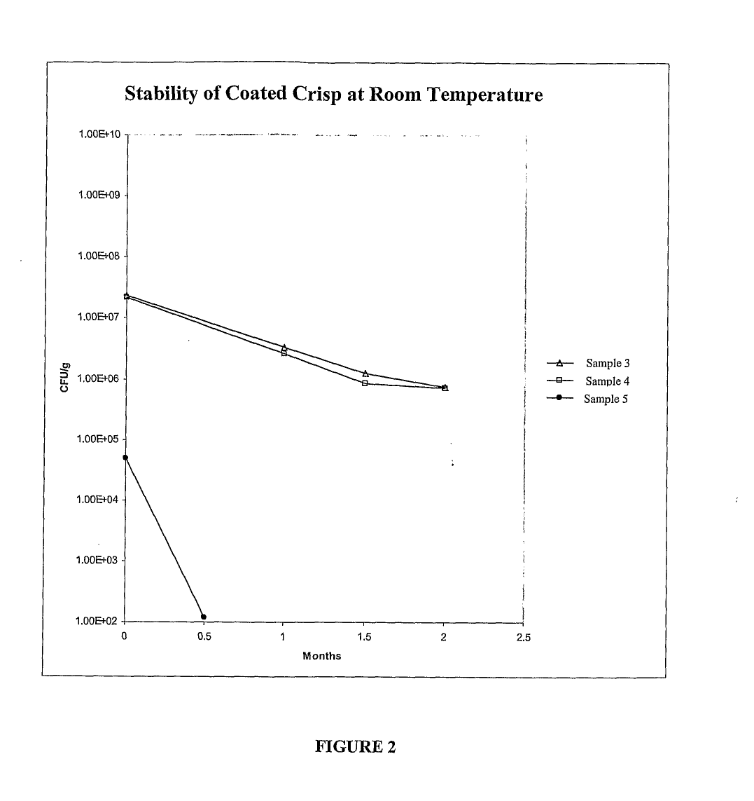

The compositions were produced approximately according to the process outlined in Example 1. The glycerine, if present, was added to the premix powder incorporating the probiotic bacteria, the salt and whey powder. Each sample was evaluated for several weeks at room temperature, i.e. about 20° C. Bacteria were extracted and the viability of the probiotic bacteria was assessed by culturing and counting colony forming units. The results of the viability of the compositions are shown in FIG. 2.

### Example 4

### Viability of Coated Cereal Crisps of the Invention Incorporated into Muesli or Cereal Bars

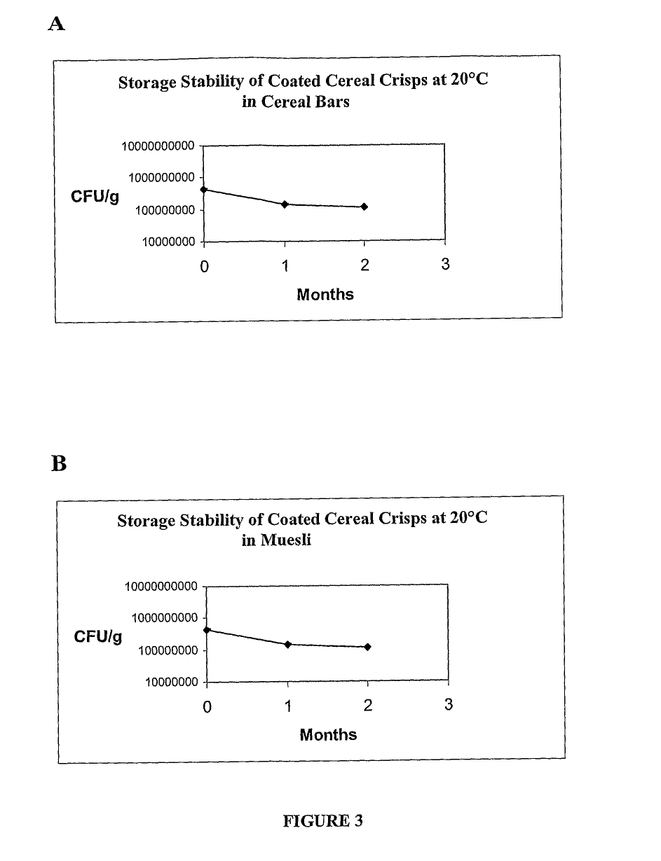

Coated cereal crisps of the invention, coated with Lactobacillus bacteria and comprising 50% fat and 30% cereal, were incorporated into muesli or cereal bars. The viability of the Lactobacillus bacteria was measured after storage of the muesli or cereal bars for several months at 20° C. Bacteria were extracted from the muesli and cereal bars, and the viability of the Lactobacillus bacteria was assessed by culturing and counting colony forming units. The results of the viability of the compositions are shown in FIG. 3 (A and B).

### Example 5

### Modified Food Product of the Present Invention

A food product made according to Example 1 was produced having the following composition:

| Component | Amount |
|---|---|
| Hydrogenated Vegetable fat | 53.65% |
| Cereal crisp | 32% |
| Sugar | 9.43% |
| Lactobacillus F19 | 2.14% |
| Salt (NaCl) | 1.72% |
| Whey powder | 1.03% |
| Vanillin | 0.02% |
| Beta carotene | 0.01% |

### Prophetic Example 6

### Production of Probiotic Coated Pretzel Using a Panning Process

800 g of a probiotic culture of Bifidobacterium animalis is mixed with 600 g NaCl and 400 g whey powder in a powder blender to form a premix powder.

12 kg of pretzels are added to a traditional panning apparatus and the panning process is started. A first shot of 150 g of melted chocolate, is poured evenly over the pretzels with a ladle to form a uniform layer. Six more layers of melted chocolate (150 g each) were then created over the pretzels by pouring the melted chocolate and allowing it to cool. An eighth shot of 150 g melted chocolate is then added to the pretzels. The probiotic premix powder is then added manually to the panning mix while the melted chocolate is still a liquid on the pretzels, and before the pretzels begin to stick together, and is distributed over the pretzels by the panning process to form a uniform layer on the melted chocolate. The melted chocolate picks up and encapsulates the probiotic bacteria during the panning process. Cold nitrogen gas is then sprayed over the panned coated cereal crisp until the coating set over the cereal crisp.

Eighty more cycles of applying 150 g melted chocolate to the coated pretzels are made according to the above description. Cooling with nitrogen gas is carried out periodically after the addition of the melted chocolate, if the pretzels appear to stick together.

The total thickness of the coating over pretzels is approximately 1.25 mm.

### Prophetic Example 7

### Incorporation of the Modified food product of Example 5 into Foods

The modified food product of Example 5 is blended into ice cream or yoghurt, mixed with muesli or incorporated into cereal snack bars. The probiotic bacteria are found to remain viable for several months after storage at 25° C. for the muesli and cereal snack bars, at 4° C. for the yoghurt and at −20° C. for the ice cream.

While the present invention has now been described and exemplified with some specificity, those skilled in the art will appreciate the various modifications, including variations, additions and omissions, that may be made in what has been described. All patents, publications and references cited herein are hereby fully incorporated by reference. In case of conflict between the present disclosure and incorporated patents, publications and references, the present disclosure should control.

1. A modified food product comprising a food product and a coating, wherein the coating comprises a fat or fat-containing composition, a probiotic microorganism and salt.

2. The modified food product of claim 1, wherein the coating further comprises at least one of a whey powder, a milk powder and a combination thereof.

3. The modified food product of claim 1, wherein the food product comprises a cereal crisp.

4. The modified food product of claim 1, wherein the coating further comprises a sugar.

5. The modified food product of claim 1, wherein the probiotic microorganism comprises a Lactobacillus species.

6. The modified food product of claim 1, wherein the coating comprises a plurality of layers of the fat or fat-containing composition.

7. The modified food product of claim 6, wherein the coating comprises at least ninety layers of the fat or fat-containing composition, and wherein at least eighty of the layers of the fat or fat-containing composition are layered over the probiotic microorganism and the salt.

8. The modified food product of claim 5, wherein the coating has a thickness of at least about 0.25 mm and less than about 2 mm.

9. A food comprising the modified food product of claim 1.

10. The food of claim 9, wherein the food comprises at least one of a breakfast cereal, muesli, cereal bar, ice cream and a combination thereof.

11. A modified food product comprising a food product and a coating, wherein the coating comprises a fat or fat-containing composition, a probiotic microorganism and at least one of a whey powder, a milk powder and a combination thereof.

12. The modified food product of claim 11, wherein the food product comprises a cereal crisp.

13. The modified food product of claim 11, wherein the coating further comprises sugar.

14. The modified food product of claim 11, wherein the coating comprises a plurality of layers of the fat or fat-containing composition.

15. The modified food product of claim 14, wherein the coating has a thickness of about 0.25 mm to about 2 mm.

16. The modified food product of claim 11, wherein the coating comprises at least ninety layers of the fat or fat-containing composition, and wherein at least eighty of the layers of the fat or fat-containing composition are layered over the probiotic microorganism and the salt.

17. A food comprising the modified food product of claim 11.

18. The food of claim 17, wherein the food comprises at least one of a breakfast cereal, muesli, cereal bar, ice cream and a combination thereof.

19. A method for producing a modified food product comprising:
(a) adding a fat or fat-containing composition and a probiotic microorganism to a food product; and
(b) panning the food product with the fat or fat-containing composition and the probiotic microorganism to make a modified food product.

20. The method of claim 19, wherein the fat or fat-containing composition of step (a) is poured over the food product.

21. The method of claim 19, further comprising:
(c) cooling the modified food product of step (b); and
(d) adding a further fat or fat-containing composition to the modified food product of step (c) and panning the modified food product to create a layer of fat or fat-containing composition onto the modified food product.

22. The method of claim 21, further comprising creating a plurality of layers of fat or fat-containing composition onto the modified food product by repeating step (d).

23. The method of claim 22, wherein step (d) is repeated at least 70 times.

24. The method of claim 19, further comprising adding salt, whey powder or milk powder to the food product in step (a).

25. The method of claim 24, further comprising adding salt and whey powder or milk powder to the food product in step (a).

26. The method of claim 21, further comprising:
(e) adding sugar to the modified food product in step (d).
